(19) United States
(12) Patent Application Publication
(10) Pub. No.: US 2025/0245432 A1
(43) Pub. Date: Jul. 31, 2025

(54) METHOD FOR LLM INFERENCE AND SYSTEM USING THE SAME

(71) Applicant: MEDIATEK INC., Hsinchu City (TW)

(72) Inventors: Yue-Ting PAN, Hsinchu City (TW); Huai-Ting LI, Hsinchu City (TW); Yi-Min TSAI, Hsinchu City (TW); Ya-Lin HUANG, Hsinchu City (TW); I-Lin CHEN, Hsinchu City (TW)

(21) Appl. No.: 19/036,087

(22) Filed: Jan. 24, 2025

Related U.S. Application Data
(60) Provisional application No. 63/624,822, filed on Jan. 25, 2024.

(51) Int. Cl. G06F 40/284; G06F 40/40; G06N 3/047

(52) U.S. Cl. CPC G06F 40/284; G06F 40/40; G06N 3/047

(57) ABSTRACT

A method for LLM inference is provided. The method includes: receiving an input prompt; generating sequentially multiple draft tokens based on the input prompt by a draft model; generating multiple answer tokens in parallel based on the multiple draft tokens by a target model; and verifying at least one of the draft tokens. The verification result indicates that, when a ratio of a first probability of one of the draft tokens to a second probability of the one of the draft tokens is larger than a threshold which is lower than 1, or the one of the draft tokens is identical to a corresponding one of the answer tokens, the one of the draft tokens passes the verification.

This application claims the benefit of U.S. provisional application Ser. No. 63/624,822, filed Jan. 25, 2024, the subject matter of which is incorporated herein by reference.

### TECHNICAL FIELD

The disclosure relates in general to method for large language models (LLM) inference, and more particularly to system using the same.

### BACKGROUND

The need for application of generative artificial intelligent (GAI) increases explosively in recent years, which the need for GAI is also increasing on edging devices or portable devices, such as smart phone. Considering characteristics of current autoregressive LLM inference, the autoregressive LLM inference generates tokens sequentially, which is often not bottlenecked by arithmetic operations, but by memory cache time. Thus, the capability of the autoregressive LLM inference is restricted, especially on edging devices or portable devices. Accordingly, there is a need for an LLM inference method that generates a higher number of tokens per second to boost user experience.

### SUMMARY

The present disclosure describes techniques of union method for speculative decoding (Spec-Dec) for AR large language model (LLM) inference.

The first aspect of the present disclosure features a method for larger language model (LLM) inference. The method includes receiving an input prompt. The method also includes generating sequentially multiple draft tokens based on the input prompt by a draft model. The method also includes generating multiple answer tokens in parallel based on the multiple draft tokens by a target model. The method also includes verifying at least one of the draft tokens. The verification result indicates that, when a ratio of a first probability of one of the draft tokens to a second probability of the one of the draft tokens is larger than a threshold which is lower than 1, or the one of the draft tokens is identical to a corresponding one of the answer tokens, the one of the draft tokens passes the verification. The first probability of one of the draft tokens is generated by the draft model, and the second probability of the one of the draft tokens is generated by the target model. When the one of the draft tokens passes the verification, the one of the draft tokens are accepted, and a token, obtained from the one of the draft tokens or the corresponding one of the answer tokens, is appended into a response for the input prompt.

In some implementations according to the first aspect of the present disclosure, the token is the one of the draft tokens.

In some implementations according to the first aspect of the present disclosure, when the one of the draft tokens passes the verification and all draft tokens before the one of the draft tokens pass the verification, the one of the draft tokens is accepted.

In some implementations according to the first aspect of the present disclosure, the multiple draft tokens is γ draft tokens. An ith draft token is generated by the draft model based on an (i−1)th draft token input to the draft model, i is greater than 1 and less than or equal to γ.

In some implementations according to the first aspect of the present disclosure, generating multiple answer tokens in parallel based on the multiple draft tokens includes generating multiple tokens in parallel based on the multiple draft tokens. The multiple tokens include the multiple answer tokens and an additional token. The additional token is generated based on the last draft token in the multiple draft tokens.

In some implementations according to the first aspect of the present disclosure, the multiple tokens include γ answer tokens and the additional token. A first answer token is generated based on the input prompt, an ith answer token is generated based on the first to i−1th draft tokens, and the additional token is generated based on the first to Yth draft tokens.

In some implementations according to the first aspect of the present disclosure, the method further includes: if all of the draft tokens are accepted according to the verification result, the additional token is appended into the response.

In some implementations according to the first aspect of the present disclosure, the method further includes: if all of the draft tokens are accepted, the draft model receives the last draft token in the multiple draft tokens and generates KV cache of the last draft token.

In some implementations according to the first aspect of the present disclosure, the method further includes: if not all of the draft tokens are accepted according to the verification result, an accepted draft token subset is appended into the response, a token probability distribution of the next position of the accepted draft token subset is adjusted, and a next token is obtained based on the adjusted token probability distribution and appended into the response.

In some implementations according to the first aspect of the present disclosure, the method further includes: if not all of the draft tokens are accepted according to the verification result, KV cache of an unaccepted draft token is removed.

In some implementations according to the first aspect of the present disclosure, the method further includes: if not all of the draft tokens are accepted according to the verification result, KV cache of the answer token corresponding to an unaccepted draft token is removed.

In some implementations according to the first aspect of the present disclosure, the ratio of the first probability of the one of the draft tokens to the second probability of the one of the draft tokens is referred as

$$\frac{{p}_{i} ( {x}_{q} )}{{q}_{i} ( {x}_{q} )} .$$

x_{q} represents the one of the draft tokens. pᵢ(x_{q}) represents the second probability of the one draft token x_{q} at position i and qᵢ(x_{q}) represents the first probability of the one draft token x_{q} at position i.

In some implementations according to the first aspect of the present disclosure, when

$$( \frac{{p}_{i} ( {x}_{q} )}{{q}_{i} ( {x}_{q} )} > {r}_{i} ) ‖ ( {x}_{p} == {x}_{q} ) ,$$

the draft token x_{q} of the draft tokens at position i pass the verification. When

$$( \frac{{p}_{i} ( {x}_{q} )}{{q}_{i} ( {x}_{q} )} < {r}_{i} ) \& \& ( {x}_{p} ! = {x}_{q} ) ,$$

the draft token x_{q} at position i does not pass the verification. xₚ represents the corresponding one of the answer tokens, and rᵢ.is the threshold which is between 0.1 and 0.9.

In some implementations according to the first aspect of the present disclosure, the method further includes generating sequentially a second group of draft tokens based on the input prompt by the draft model, and generating a second group of answer tokens in parallel based on the second group of draft tokens and the additional token generated by the target model if all of the draft tokens are accepted.

In some implementations according to the first aspect of the present disclosure, the method further includes generating sequentially a second group of draft tokens based on the input prompt by the draft model, and outputting a second group of answer tokens in parallel based on the second group of draft tokens and the obtained next token generated by the target model if not all of the draft tokens are accepted.

The second aspect of the present disclosure features a system for LLM inference. The system includes a processor, configured to receive an input prompt, generate sequentially multiple draft tokens based on the input prompt by running a draft model, generate multiple answer tokens in parallel based on the multiple draft tokens by running a target model, verify at least one of the draft tokens. The verification result indicates that, when a ratio of a first probability of one of the draft tokens to a second probability of the one of the draft tokens is larger than a threshold which is lower than 1, or the one of the draft tokens is identical to a corresponding one of the answer tokens, the one of the draft tokens passes the verification. The first probability of one of the draft tokens is generated by the draft model, and the second probability of one of the draft tokens is generated by the target model. When the one of the draft tokens passes the verification, the one of the draft tokens are accepted, and a token, obtained from the one of the draft tokens or the corresponding one of the answer tokens, is appended into a response for the input prompt.

In some implementations according to the second aspect of the present disclosure, the processor includes a CPU and a NPU. The NPU is configured to receive an input prompt, generate sequentially multiple draft tokens based on the input prompt by running a draft model, and generate multiple answer tokens in parallel based on the multiple draft tokens by running a target model. The CPU is configured to verify at least one of the draft tokens and notify the NPU which draft tokens are accepted.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a diagram illustrating the generation mode and the prompt mode, according to one or more implementations of the present disclosure.

FIG. 2 is a diagram illustrating the generation mode for autoregressively generating tokens, according to one or more implementations of the present disclosure.

FIG. 3 is a diagram illustrating the prompt mode for generating tokens in parallel, according to one or more implementations of the present disclosure.

FIG. 4 is a diagram illustrating a speculative decoding (Spec-Dec) for large language models (LLM) inference, according to one or more implementations of the present disclosure.

FIG. 5 is a flowchart illustrating the process of Spec-Dec for LLM inference, according to one or more implementations of the present disclosure.

FIG. 6 is a diagram illustrating a comparison between the conventional method and the union method, according to one or more implementations of the present disclosure.

FIG. 7 is a graph illustrating a threshold upper bound trading off between speedup and quality, according to one or more implementations of the present disclosure.

FIG. 8 is a diagram illustrating the union method, according to one or more implementations of the present disclosure.

FIG. 9 is a diagram illustrating a comparison between the conventional method and the union method in acceptance rate, speedup and quality, according to one or more implementations of the present disclosure.

FIG. 10 is a function block diagram illustrating a draft model and a target model for digesting input prompt, according to one or more implementations of the present disclosure.

FIG. 11 is a function block diagram illustrating the target model for generating draft tokens and the draft model for generating answer tokens, according to one or more implementations of the present disclosure.

FIG. 12 is a function block diagram illustrating a system for Spec-Dec using the union method, according to one or more implementations of the present disclosure.

FIG. 13 is a flowchart illustrating the process for Spec-Dec using the union method, according to one or more implementations of the present disclosure.

FIG. 14 is a diagram illustrating fulfilling KV cache for draft model, sampling new token and rolling back KV cache, of Spec-Dec using the union method, according to one or more implementations of the present disclosure.

FIG. 15 is a system for LLM inference.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Techniques including flexible mechanism of the union method for a Spec-Dec to tradeoff between the response quality and the speedup are provided according to some implementations of the present disclosure, which is also referred as “lossy Spec-Dec”. By applying this technique of union method for Spec-Dec provided by the present disclosure, portable devices, such as smart phone or tablets, are enabled to support LLM inference and achieve higher numbers of tokens per second to boost user experience.

Techniques including another mechanism of the union method for Spec-Dec for modifying verification conditions to accept bit-true cases (treasure tokens) is also provided according to some implementations of the present disclosure, which increases the acceptance rate and also accelerates LLM inference.

Accordingly, those techniques of the union method for Spec-Dec according to some implementations of the present disclosure are enabled to keep user experience without insignificantly quality dropping while speeding up the generation process, which would be effective and flexible in certain applications with the minimum quality loss.

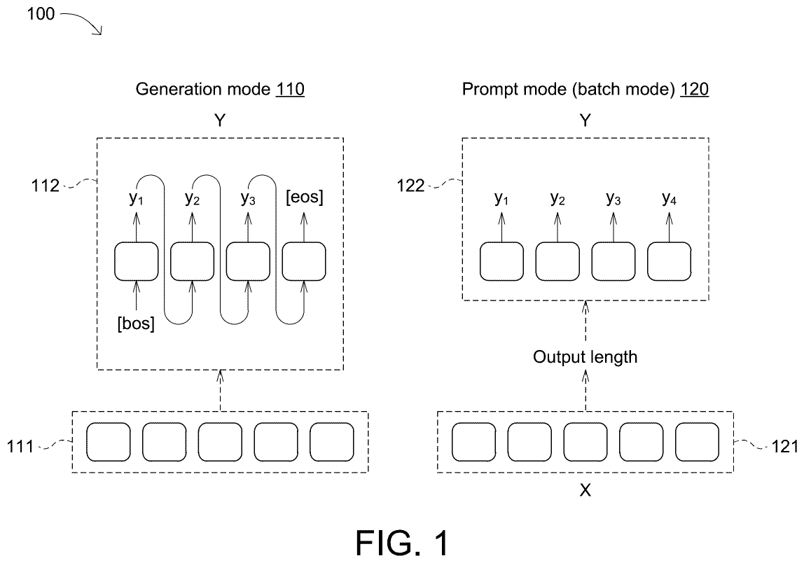

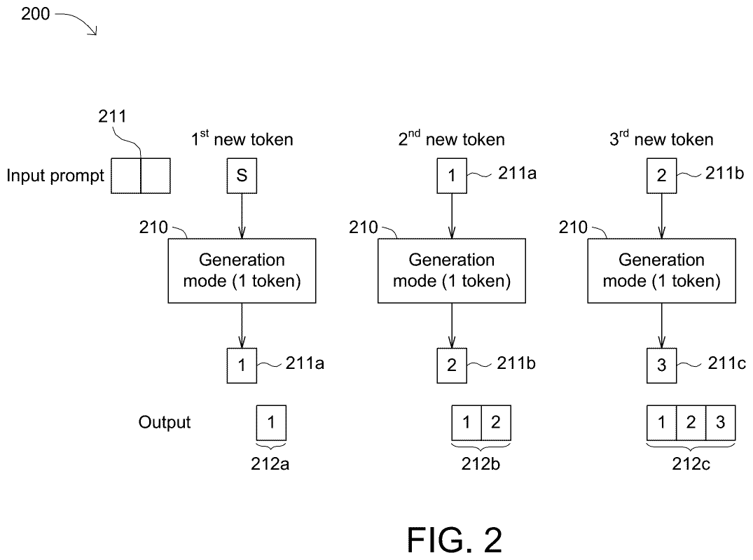

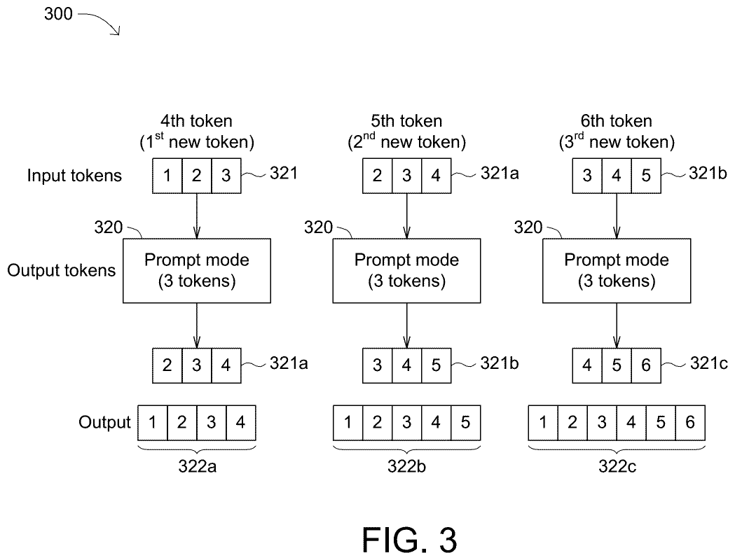

FIG. 1 is a diagram 100 illustrating the generation mode 110 and the prompt mode 120, according to one or more implementations of the present disclosure. While applying the generation mode 110, each of output tokens 112 is generated one by one, correspondingly, as shown, which is effective for autoregressive generating tokens from only one input token. While applying prompt mode (or batch mode) 120, a group of input tokens 121 (e.g., X in FIG. 1) can be input simultaneously and a group of output tokens 122 are generated correspondingly, wherein the group of input tokens 121 may be the output tokens of the generation mode in the application. The generation mode 110 and the prompt mode 120 will be further detailed described referring to FIGS. 2 and 3, respectively, as following.

FIG. 2 is a diagram 200 illustrating the generation mode 210 for autoregressively generating tokens, according to one or more implementations of the present disclosure. As shown in FIG. 2, the first output token 221a, which is denoted by “1”, is generated as a first new token according to a single token S and a past information, by the generation mode 210, wherein the single token S may be the last token of the input prompt, and the past information is obtained based on the input prompt and stored in the generation mode 210. As discussed above, in one time, only one token (token “S” in this case) can be input in the generation mode 210. The output 212a includes the first output token 211a. Similarly, the second output token 211b, which is denoted by “2”, is generated according to the first output token 211a and the past information, as a second new token, by the generation mode 210. The output 212b includes the first output token 221a and the second output token 211b. Then, similarly, the third output token 211c is generated according to the second output token 211b, information of the first output token 211a and the past information, as a third new token, by the generation mode 210. The information of the first output token 211a is stored in the generation mode 210 after the first output token 211a is generated. The output 212c includes the first output token 221a, the second output token 211b and the third output token 211c. Accordingly, in the output 212a˜212c, one new token is generated on the last position of the output. In this embodiment, 1, 2, and 3 in the FIG. 2 denotes the position of corresponding token in the output.

FIG. 3 is a diagram 300 illustrating the prompt mode 320 for generating tokens in parallel, according to one or more implementations of the present disclosure. As shown in FIG. 3, while the prompt mode 320 generates tokens, the first output tokens 321a, which are at positions “2”, “3” and “4”, are generated according to input tokens 321, which are at positions “1”, “2” and “3”, wherein a first new token position 4 is generated and a first new token is generated at position 4 (also referring to the fourth token considering previous 3 input tokens in generation mode 210 of FIG. 2) is generated. As discussed above, a group of input tokens can be input simultaneously and a group of output tokens 321a are generated correspondingly according to the numbers of the input tokens, which is 3 in this case. The output 322a includes the output tokens 321a and the first new token at position 4. Similarly, the second output tokens 321b, which are at positions “3”, “4” and “5”, are generated according to the first output tokens 321a, which are positions “2”, “3” and “4”, wherein a second new token position 5 is generated and the second new token (also referring to the fifth token) is generated at position 5. The output 322b includes tokens at positions 1, 2, 3, 4, and 5. Then, similarly, the third output tokens 321c, which are at positions “4”, “5” and “6”, are generated according to the second output tokens 321b, which are at positions “3”, “4” and “5”, wherein a third new token position 6 is generated and a third new token (also referring to the sixth token) is generated at position 6. The output 322c includes tokens at positions 1, 2, 3, 4, 5, and 6.

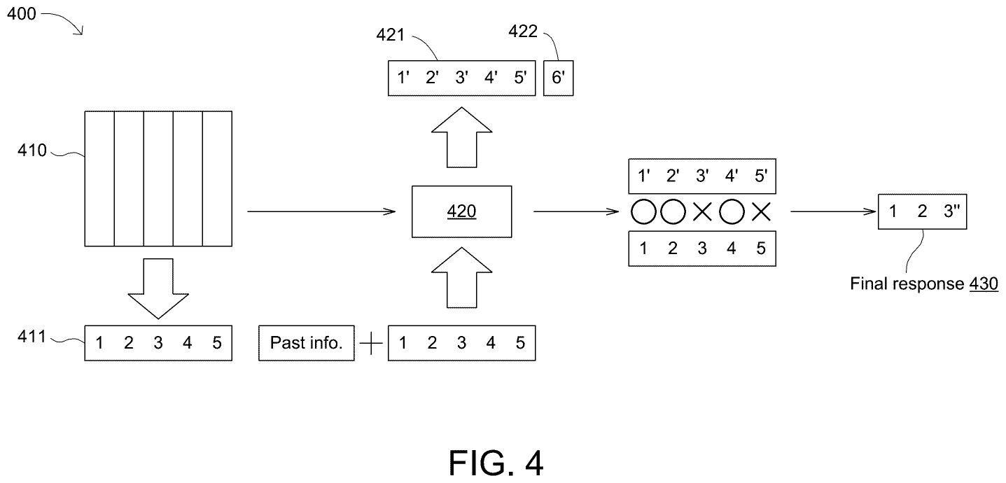

From the above description, it can be seen that the token/sec (the number of tokens generated per second) of prompt mode is larger than that of generation mode. Thus, a large model and a small model may collaborate to yield a response for the input prompt. In some implementations, the large model is implemented with the prompt mode (such as the prompt mode 320 of FIG. 3) as a target model (such as target model 420 of FIG. 4), and the small model is implemented with the generation mode (such as the generation mode 210 of FIG. 2) as a draft model (such as draft model 410 of FIG. 4). Accordingly, the combination of the generation mode (such as the generation mode 210 of FIG. 2) and the prompt mode (such as the prompt mode 320 of FIG. 3) can be used for speculative decoding (Spec-Dec) for large language model (LLM) inference. In Spec-Dec, firstly, the generation mode is used to generate sequentially multiple draft tokens. Then, the prompt mode is used to simultaneously generate multiple tokens in parallel based on the multiple draft tokens. For example, to obtain [4, 5, 6] in prompt mode, [1, 2, 3, 4′, 5′] is needed to be put as input for returning [2, 3, 4, 5, 6], but [4′, 5′] is not existing in the prompt mode. In this case, Spec-Dec applying the generation mode to guess [4′, 5′] in advance. The Spec-Dec will be further detailed described referring to FIGS. 4 to 14.

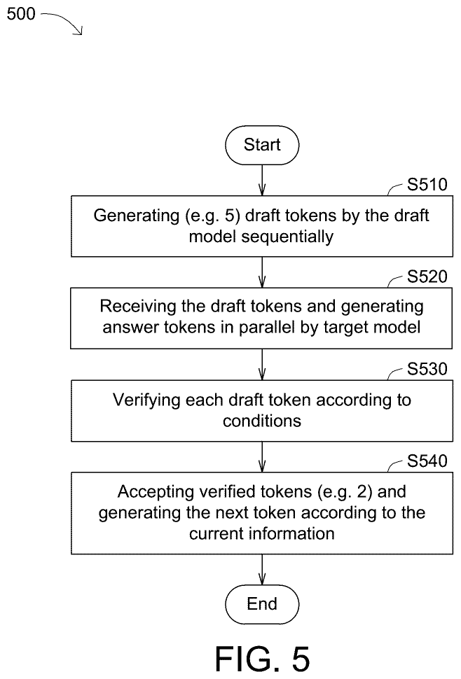

Referring to FIGS. 4 and 5, FIG. 4 is a diagram illustrating a speculative decoding (Spec-Dec) 400 for large language models (LLM) inference, according to one or more implementations of the present disclosure and FIG. 5 is a flowchart illustrating the process 500 of Spec-Dec for large language models (LLM) inference, according to one or more implementations of the present disclosure. In FIG. 4, a draft model 410 can use the generation mode, and a target model 420 can use the prompt mode, wherein the draft model 410 can also be referred as an approximate model, or a small model. In some implementations, the large model may have 7 billion parameters, and the small model may have 3 billion parameters. In some implementations, the ratio of the number of parameters of the small model to the large model for decoding is 1 to 10.

Referring to process 500 of FIG. 5, in step S510, the draft model generates multiple (e.g. 5) draft tokens sequentially, such as the draft model 410 generating each one of the draft tokens 411 sequentially, which are denoted by 1, 2, 3, 4 and 5 in FIG. 4. The 1, 2, 3, 4 and 5 denotes the positions of the corresponding tokens in the multiple draft tokens. The position i of the token denotes the ith token in the multiple draft tokens.

In this step, the generation model in the draft model is run by 5 times and generates one token each time. The first draft token may be generated based on past information, the second draft token is generated based on the first draft token and past information, the third draft token is generated based on the second draft token, stored information of the first draft token and past information, the fourth draft token is generated based on the third draft token, stored information of the first draft token and the second token, and past information, and the fifth draft token is generated based on the fourth draft token, stored information of the first draft token, the second draft token and the third draft token, and past information.

In some embodiments, multiple decoding steps may be required to complete the response to the input prompt. In some embodiments, for the first decoding step, the first draft token is generated based on past information, wherein the past information is generated based on an input prompt and stored in the draft model. In some embodiments, for the non-first decoding step, the first draft token is generated based on the additional token generated by the target model in previous decoding step if all draft tokens are accepted in previous decoding step. In some embodiments, for the non-first decoding step, the first draft token is generated based on sampled token generated by the target model in previous decoding step if not all draft tokens are accepted in previous decoding step.

In step S520 of FIG. 5, the multiple draft tokens are put into the target model. The target model 420 receives the multiple draft tokens and simultaneously generates multiple answer tokens and an additional token in parallel. For example, the target model 420 receives the multiple draft tokens, which are denoted by 1, 2, 3, 4 and 5 in FIG. 4, and generates multiple answer tokens and an additional token in parallel, which are denoted by 1′, 2′, 3′, 4′, 5′ and 6′. The 1′, 2′, 3′, 4′, 5′ and 6′ denotes the positions of the corresponding tokens.

In the step, the first answer token is generated based on the past information, wherein the past information is generated based on an input prompt and stored in the target model. The second answer token is generated based on the first draft token and stored information of past information, the third answer token is generated based on the second draft token, the first draft token and past information, the fourth answer token is generated based on the third draft token, the second draft token, the first draft token and past information, the fifth answer token is generated based on the fourth draft token, the third draft token, the second draft token, the first draft token and past information, and the sixth answer token is generated based on the fifth draft token, the fourth draft token, the third draft token, the second draft token, the first draft token and past information. In some embodiments, for the first decoding step, the first answer token is generated based on past information. In some embodiments, for the non-first decoding step, the first answer token is generated based on the additional token generated by the target model in previous decoding step if all draft tokens are accepted in previous decoding step. In some embodiments, for the non-first decoding step, the first answer token is generated based on sampled token generated by the target model in previous decoding step if not all draft tokens are accepted in previous decoding step.

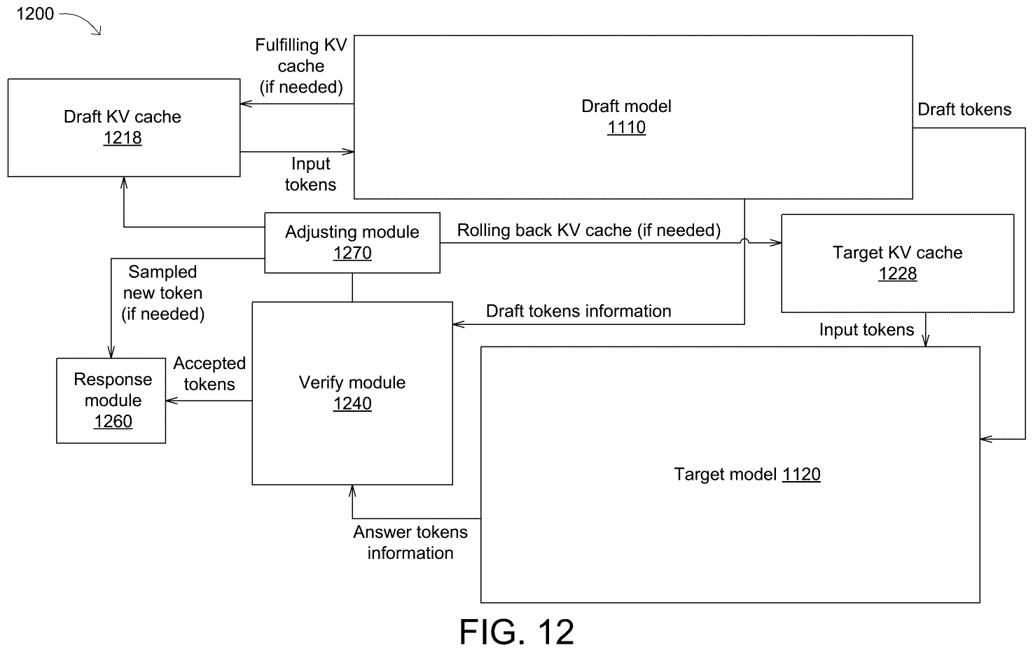

In step S530 of FIG. 5, each draft token is verified (e.g., by a verifying module such as verifying module 1240 of FIG. 12) according to “conditions” associated with the corresponding answer tokens. Specifically, the draft tokens 411, which are denoted by 1, 2, 3, 4, 5, are verified according to “conditions”, wherein draft tokens, which are denoted by 3 and 5, do not pass the verification. Only draft tokens, which are denoted by 1 and 2, pass the verification and will be accepted. Although the draft token denoted by 4 passes the verification, the draft token denoted by 4 can't be accepted because the draft token denoted by 4 is obtained based on an incorrect token denoted by 3.

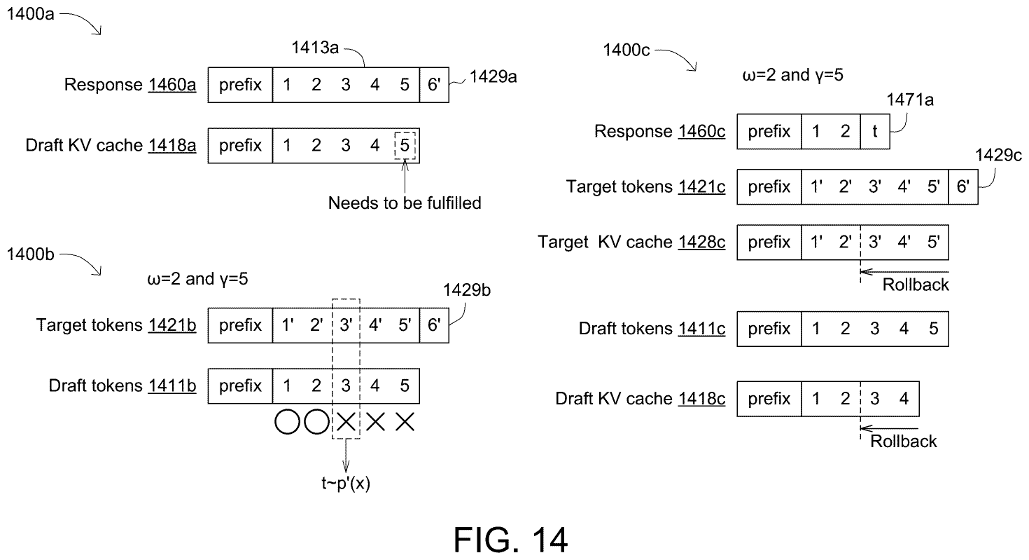

In step S540 of FIG. 5, several tokens (e.g. 2 tokens, which are denoted by 1 and 2) are accepted and the next token is generated according to the current information. The final response includes the accepted tokens and the next token. The means for generating the next token will be further detailed described as referring to sampling new token 1400b of FIG. 14. The next token is 3″ in this case of FIG. 4 is append after tokens 1 and 2. The final response 430 can be also referred to the result of the decoding step for Spec-Dec, which can be the final result of LLM inference or can be used for another decoding step for Spec-Dec. The next token is 3″ in this case of FIG. 4 may be used for next decoding step for generating the first draft token and the first answer token in the next decoding step. In some embodiments, if all draft tokens are accepted in this decoding step, the additional token is used in next decoding step for generating the first draft token and the first answer token in the next decoding step.

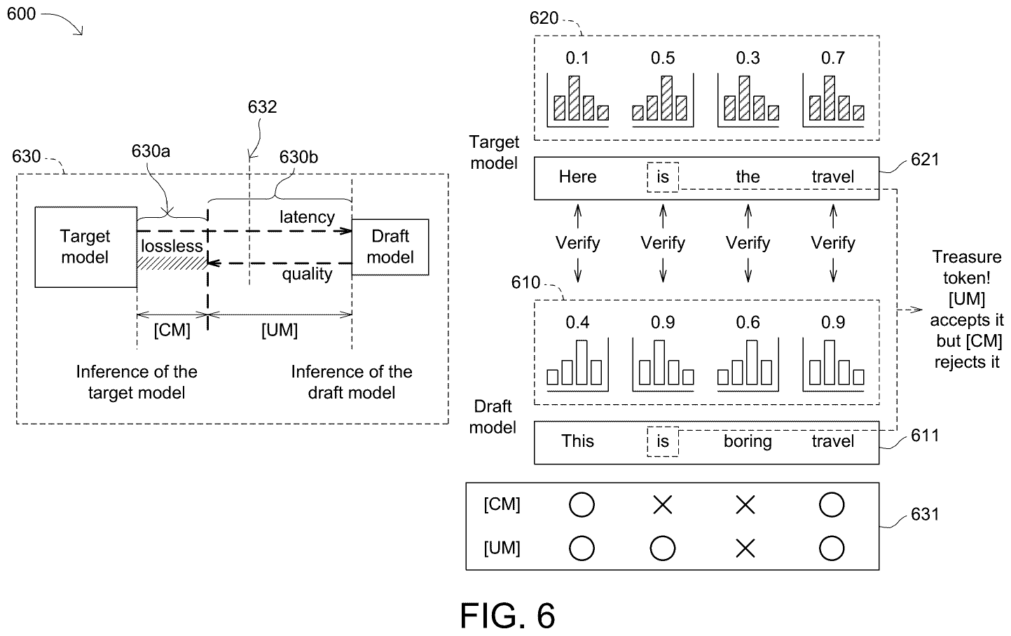

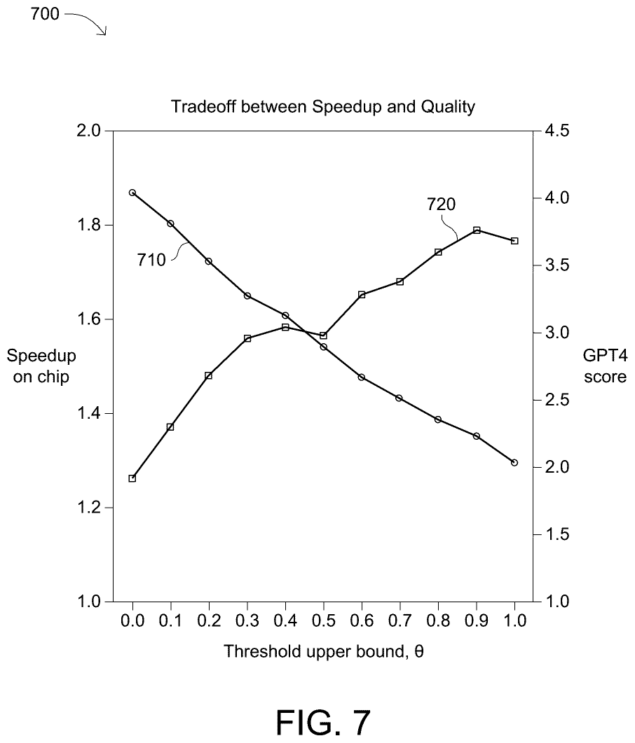

Referring to FIGS. 6 and 7, FIG. 6 is a diagram illustrating a comparison 600 between the conventional method (CM) and the union method (UM), according to one or more implementations of the present disclosure, and FIG. 7 is a graph 700 illustrating a threshold upper bound θ trading off between speedup and quality, according to one or more implementations of the present disclosure. On the left side of FIG. 6, comparing to the conventional method (CM) of Sped-Dec for ensuring quality which causes high latency of inference operations, the union method (UM) of Sped-Dec provided by the present application can be provided within a lossy range 630b outside the lossless range 630a, by preset the tradeoff point 632 within the lossy range 630b to control the tradeoff between the quality and the speed.

The “conditions” used for verifying tokens in the union method of Spec-Dec provided by present application include determining if a ratio of a first probability of the draft token in a first token probability distribution generated by a draft model to a second probability of the draft token in a second token probability distribution generated by a target model is larger than a threshold, wherein, the ratio can be referred to

$$\frac{{p}_{i} ( {x}_{q} )}{{q}_{i} ( {x}_{q} )} ,$$

wherein x_{q} represents the i^{th} token, pᵢ(x_{q}) is probability of x_{q} in the token probability distribution at the ith position for large model (target model), and qᵢ(x_{q}) is probability of x_{q} in the token probability distribution at the ith position for small model (draft model). As shown in FIG. 6, for example, “Here” is at position 1. Multiple black bars over “Here” may represent the token probability distribution at position 1, and each black bar may represent the probability of corresponding possible token in multiple possible tokens at position 1. pᵢ(x_{q}) and qᵢ(x_{q}) can be understood as confidential levels of token x_{q} of both models on i^{th} position. The threshold is sampled from uniform distribution U[0, θ], wherein the θ is smaller than 1. The draft token passes the verification if

$$\frac{{p}_{i} ( {x}_{q} )}{{q}_{i} ( {x}_{q} )} > {r}_{i} .$$

In some embodiments, θ is adjustable.

In the union method of Spec-Dec provided by present application, a meticulous tradeoff between speedup and quality is implemented as setting “the condition” such as within a lossy range 630b outside the lossless range 630a, by preset the tradeoff point 632 within the lossy range 630b to control the tradeoff between the quality and the speedup as discussed above referring to FIG. 6. To do so, a threshold upper bound θ can be set for the uniform distribution U[0, θ] and the threshold rᵢ is sampled from U[0, θ]. By doing so, the fine-grained control can be achieved between speedup and quality tradeoff. As shown in FIG. 7, various values of the threshold upper bound θ correspond to the curve 710 related to the speedup (illustrated as speed up on a chip on the left side of the graph 700), and also correspond to the curve 720 related to the quality (illustrated as Generative Pre-trained Transformer (GPT) 4 score on the right side of the graph 700). In some implementations, θ is larger than 0 and smaller than 1. In some implementations, the threshold rᵢ is preferably set up as 0.85 or 0.9. Accordingly, fine-grained control over the generation latency and response quality tradeoff can be achieved. Compared to conventional method (CM), since θ is less than 1 in the union method of Spec-Dec provided by present application, the range of possible values for the threshold rᵢ is less than θ, which is beneficial for accepting more draft tokens.

Referring back to FIG. 6, as shown on the right side, while verifying the draft tokens 611 generated by draft model, the probabilities 610 of the draft tokens 611 generated by draft model and the probabilities 620 of answer tokens 621 generated by target model are used in the “condition”. For example, in the FIG. 6, the probability ratio of the second token is determined as 0.5/0.9. The second token will does not pass the verification if threshold rᵢ is set up as 0.5 (within the range from 0.1 to 0.9 or from 0.1 to 0.85). However, the second token, “is”, of the draft tokens 611 is identical to the second token, “is”, of answer tokens 621, which is omitted due to the determined probability ratio is smaller than the corresponding threshold, and the second token is considered as treasure token. The proposed the union method in Spec-Dec provided by the present application, is also proposed to explore omitted treasure tokens discussed above.

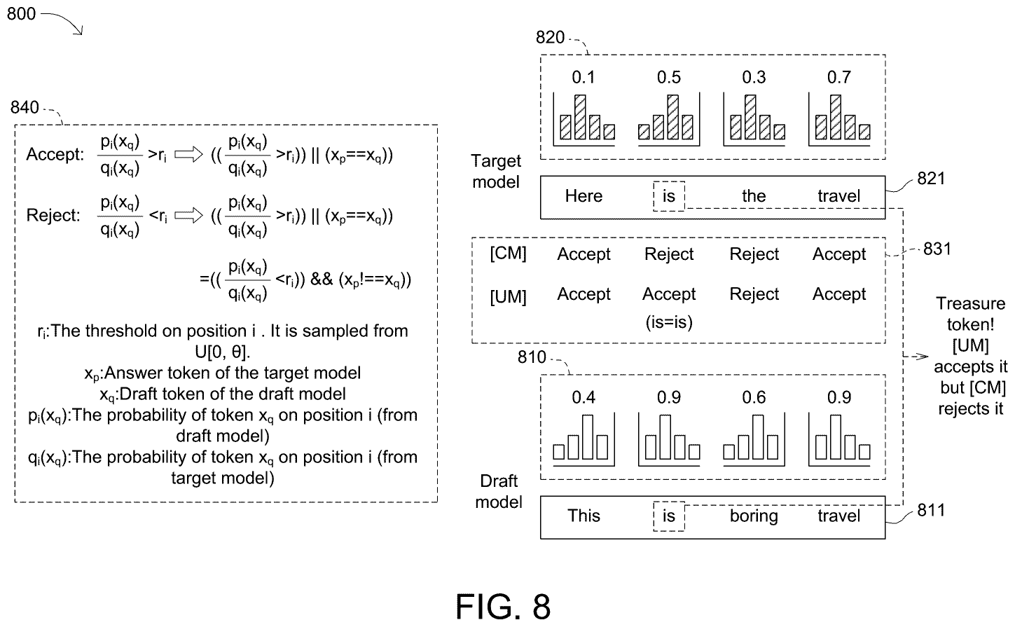

FIG. 8 is a diagram illustrating the union method in Spec-Dec provided by the present application using the condition 840 for tokens verifying, according to one or more implementations of the present disclosure. Compared with conventional method (CM), the union method of Spec-Dec provided by the present application may accept more tokens while maintaining the response quality. As shown in FIG. 8, it can be achieved by setting up the condition 840, which can be referred as follows:
Token is accepted if

$$( ( \frac{{p}_{i} ( {x}_{q} )}{{q}_{i} ( {x}_{q} )} > {r}_{i} ) ‖ ( {x}_{p} == {x}_{q} ) ) ,$$

or token is rejected if

$$¬ ( ( \frac{{p}_{i} ( {x}_{q} )}{{q}_{i} ( {x}_{q} )} > {r}_{i} ) ‖ ( {x}_{p} == {x}_{q} ) ) = ( ( \frac{{p}_{i} ( {x}_{q} )}{{q}_{i} ( {x}_{q} )} < {r}_{i} ) \& \& ( {x}_{p} ! = {x}_{q} ) ) ,$$

wherein, rᵢ is the threshold on position i, which is sampled from U[0,θ] as discussed above, x_{q} represents a draft token on position i, pᵢ(x_{q}) is the first probability of token x_{q} on position i generated from the draft model, and qᵢ(x_{q}) is the second probability of token x_{q} on position i from the target model, and wherein “∥” represents “or”, “==” represents “identical to”, and “¬” represents “inverting”, “&&” represents “and”.

As shown in verifying results 831 of FIG. 8, the second token, “is”, of the draft tokens 811 is accepted due to it is identical to the second token, “is”, of the target tokens 821 according to the condition: (xₚ==x_{q}). In the conventional method (CM), the second token, “is”, of the draft tokens 811 is rejected.

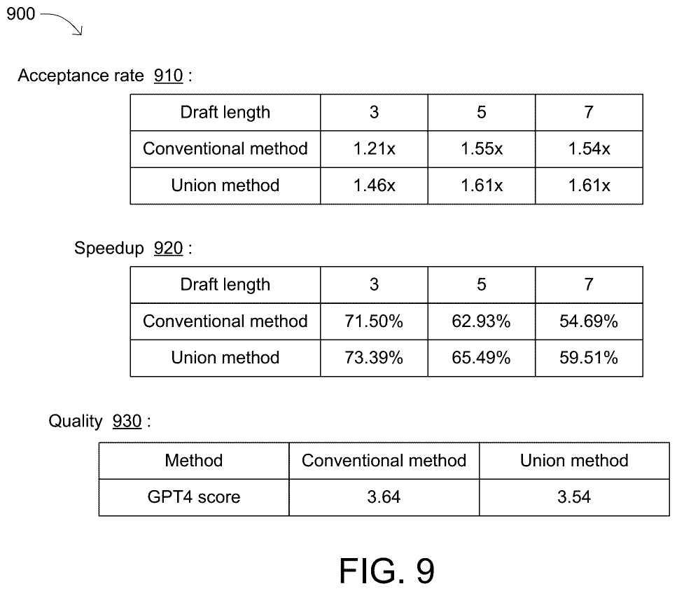

FIG. 9 is a diagram illustrating a comparison 900 between the conventional method and the union method according to one or more implementations of the present disclosure, in acceptance rate 910, speedup 920 and quality 930. As shown in FIG. 9, the proposed Union method can improve the acceptance rate of tokens (as shown in acceptance rate 910) and further increase the speedup factor (as shown in speedup 920), with light loss of quality (GPT4 score can reach 3.54).

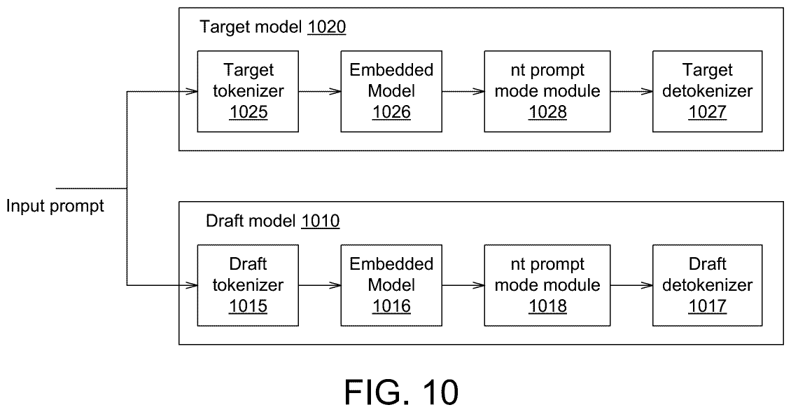

FIG. 10 is a function block diagram illustrating a draft model 1010 and a target model 1020 for digesting input prompt, according to one or more implementations of the present disclosure. To digest the input prompt, the target model 1020 includes a target tokenizer 1025, an embedded model 1026, a target detokenizer 1027 and a nt prompt mode module 1028 (n>1). The target tokenizer 1025 is used for translating character representation of each token in the input prompt into a mathematical representation. The embedded model 1026 is used for converting the mathematical representation of each token into a vector representation of corresponding token. The nt prompt mode module 1028 is used for digesting a vector representation of each token, generating KV cache of the input prompt, storing the KV cache of the input prompt in the buffer as the past information for the following procedure. The nt prompt mode module 1028 is also used for generating a first new token based on KV cache of the input prompt. The first new token is in a mathematical representation. The target detokenizer 1027 is used for converting the mathematical representation of the first new token into a character representation of the first new token.

Similarly, to digest the input prompt, the draft model 1010 includes a draft tokenizer 1015, an embedded model 1016, a draft detokenizer 1017, and a nt prompt mode module 1018 (n>1). The functions of the draft tokenizer 1015, the embedded model 1016 and the nt prompt mode module 1018 (n>1) may similar to the target tokenizer 1025, the embedded model 1026 and the nt prompt mode module 1028 (n>1). The difference may be that the draft model 1010 does not need to generate the first new token when digesting the input prompt.

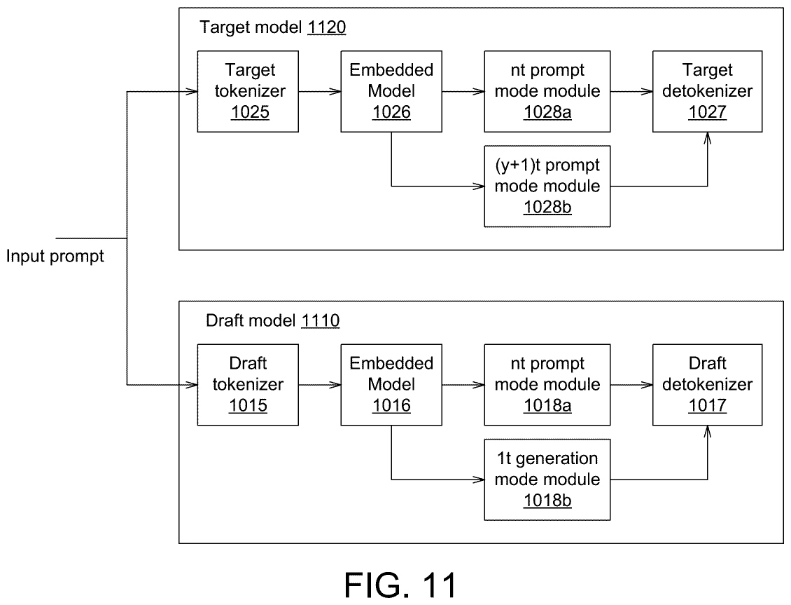

FIG. 11 is a function block diagram illustrating the target model 1120 for generating draft tokens and the draft model 1110 for generating answer tokens, according to one or more implementations of the present disclosure.

The target model 1120 includes the target tokenizer 1025, the embedded model 1026, the target detokenizer 1027, the nt prompt mode module 1028a (n>1), and a (γ+1)t prompt mode module 1028b. The target tokenizer 1025 is further used for translating character representation of the multiple input draft tokens into a mathematical representation of the multiple input draft tokens. The embedded model 1026 is used for converting the mathematical representation of the multiple input draft tokens into vector representation of the multiple input draft tokens. The (γ+1)t prompt mode module 1028b is used for generating mathematical representation of multiple answer tokens and an additional token. The target detokenizer 1027 is used for converting the mathematical representation of the multiple answer tokens and the additional token into character representation of the multiple answer tokens and the additional token.

The draft model 1110 includes the draft tokenizer 1015, the embedded model 1016, the draft detokenizer 1017, the nt prompt mode module 1018a (n>1), and a 1 t generation mode module 1018b. The draft tokenizer 1015 is further used for translating character representation of each input token into a mathematical representation of corresponding input token. The embedded model 1016 is used for converting the mathematical representation of each input token into a vector representation of corresponding input token. The 1 t generation mode module 1018b is used for generating a mathematical representation of an output draft token based on the vector representation of corresponding input token. The draft detokenizer 1017 is used for translating the mathematical representation of the output draft token into a character representation of the output draft token.

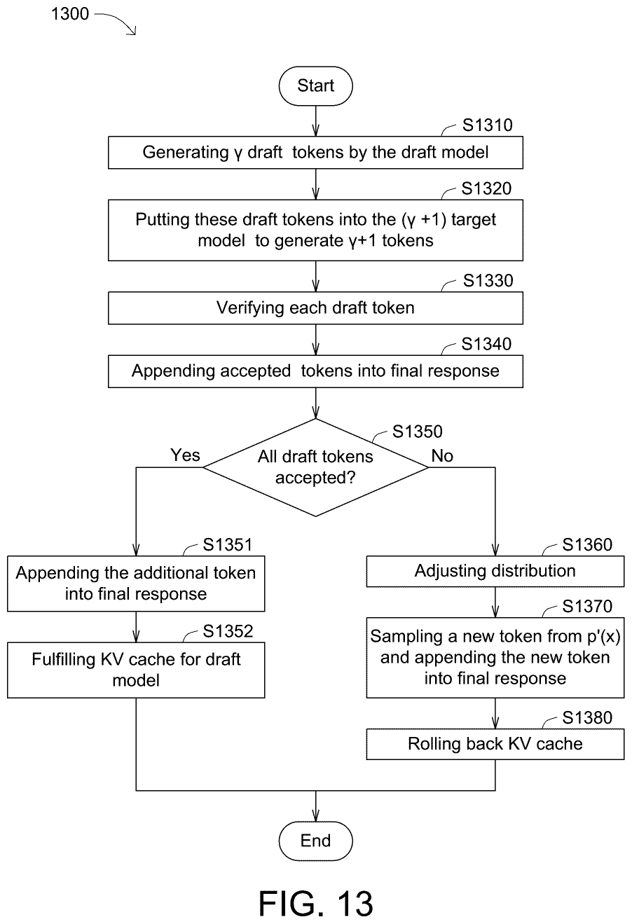

Referring to FIGS. 12 to 14, FIG. 12 is a function block diagram illustrating a system 1200 for Spec-Dec using the union method, FIG. 13 is a flowchart illustrating the process 1300 for Spec-Dec using the union method, according to one or more implementations of the present disclosure, and FIG. 14 is a diagram illustrating fulfilling KV cache for draft model 1400a, sampling new token 1400b and rolling back KV cache 1400c, of Spec-Dec using the union method, according to one or more implementations of the present disclosure.

Firstly, γ draft tokens are generated by the draft model 1110 (as shown in step S1310 of FIG. 13), wherein γ is an integer larger than or equal to 1, and for purpose of explanation, γ is 5 in this case. The draft model 1110 including 1 t (one token) generation mode runs 1 t generation mode by γ times, and generates sequentially γ draft tokens and information of γ draft tokens. The information of each of γ draft tokens includes the identifier (id) and logit of corresponding draft token, wherein the logit of corresponding draft token denotes the probability of corresponding draft token.

Then, the draft tokens are input to the target model 1120. The target model 1120 runs the (γ+1)t (which is 5+1 tokens in this example) prompt mode (as shown in step S1320 of FIG. 13) to generate γ+1 tokens and information of γ+1 answer tokens. γ+1 tokens include γ answer tokens and one additional token. The information of γ answer tokens includes ids and logits of γ answer tokens. The information of the one additional token includes id and logit of one additional token, wherein the logit of corresponding token denotes the probability of corresponding token.

As shown in step S1330 of FIG. 13, each draft token (such as each of γ draft tokens) is verified according to the conditions. In this step, the verify module 1240 receives information of γ draft tokens and information of γ answer tokens and determines which draft tokens should pass the verification according to the conditions of mentioned union method and determines the accepted tokens. The accepted tokens that pass the verification are consecutive tokens. Then, the accepted draft tokens are appended into final response by the response module 1260 (as shown in step S1340 of FIG. 13).

As in step S1350 of FIG. 13, it can be determined that if all draft tokens are accepted according to the verification result of the verify module 1240 of FIG. 12. If yes, the additional token is appended into final response by the response module 1260 (as shown in step S1351 of FIG. 13). Since the draft KV cache 1218 is used for putting KV caches of input tokens to the draft model 1110 for generating γ draft tokens, the draft KV cache 1218 includes KV caches of (γ−1) input tokens. Thus, draft model 1110 should run 1 t generation mode again to generate KV cache of γth input token to fulfill the draft KV cache 1218 (as shown in step S1352 of FIG. 13). This also can be referring to fulfilling KV cache for draft model 1400a of FIG. 14. As shown, the (final) response 1460a includes accepted γ draft tokens 1413a (which γ is 5 in this case) and the additional token 1429a (such as the additional token generated by the (γ+1)t prompt mode of target model 1120 of FIG. 12), which the number of tokens is (γ+1) (which is 6 in this case). Thus, the draft model 1110 should run 1 t generation mode again to receive the Y draft token and generate KV cache of γth draft token to fulfill the draft KV cache 1218.

Referring back to S1350 of FIG. 13, if not all tokens are accepted, the adjusting module 1270 of FIG. 12 adjusts a token probability distribution of the next position of the accepted tokens (as shown in step S1360 of FIG. 13). In the step S1370, the adjusting module 1270 determines the next token based on the adjusted token probability distribution. This also can be referring to sampling a new token as the next token of the accepted tokens. Presuming that the verification result of the draft tokens 1411b is that first ω out of γ tokens are accepted, which ω=2 and γ=5 in this case. Since the first ω of γ tokens is accepted, the probability distribution of token at position ω+1 will be adjusted. Assume new token probability distribution at position ω+1 is p′(x), and p′(x)=normalize(max(p_{w+1}(x)−q_{w+1}(x), 0)), wherein x denotes a token in vocabulary bank. Then, a sampled new token t can be obtained based on p′(x) which can be represented by t˜p′(x), and the sampled new token, t, can be appended into final response.

Since not all tokens are accepted, the KV cache of the target model and the draft model should be rollbacked (as shown in step S1380 of FIG. 13). In some implementation, as shown in FIG. 12, the draft KV cache 1218 and the target KV cache 1228 can be rolled back by the adjusting module 1270. This also can be referring to rolling back KV cache 1400c of FIG. 14. Presuming that the verification result of the draft tokens 1411c is that the first ω out of γ tokens are accepted, which ω=2 and γ=5 in this case. Since the first ω of γ tokens are accepted, the final response 1460c includes the first 2 tokens of the draft tokens 1411c and a sampled new token 1471a represented by t (as described referring to sampling new token 1400b of FIG. 14). For the target model, the KV cache of answer tokens (i.e. answer token corresponding to rejected draft token) after the first 2 tokens (i.e. answer token corresponding to accepted draft tokens) should be rolled back (also referred to be removed), as shown in the target KV cache 1228 in FIG. 12. For the draft model, the KV cache of draft tokens (i.e. rejected tokens) after the first 2 tokens (i.e. accepted tokens) should be rolled back (also referred to be removed), as shown in the draft KV cache 1218 of FIG. 12. After that, one decoding step ends, and the next decoding step can be repeated again according to the mentioned steps.

Techniques of proposed union method can be apply to, not limited to, Spec-Dec based methods for inference, such as Spec-Dec, Medusa, EAGLE and the like, to improve processing speed for those methods for inference. Techniques of proposed union method for Spec-Dec may be executed in CPU, NPU (Neural processing Unit) and the like, and may be executed in portable devices comprising those, such as smartphone, PDA or tablet. Specifically, the NPU may run the draft model and the target model. CPU may perform the verification operation, determine which draft tokens can be accepted and notify the NPU which draft tokens can be accepted. In FIG. 12, the draft mode, the target module and response module may in the NPU.

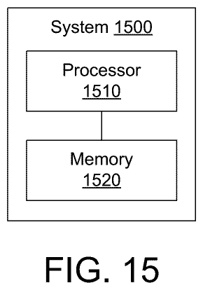

FIG. 15 shows a system 1500 for LLM inference. The system includes a processor 1510 and a memory 1520. The processor 1510 is configured to receive an input prompt, generate sequentially multiple draft tokens based on the input prompt by running a draft model, generate multiple answer tokens in parallel based on the multiple draft tokens and the input prompt by running a target model, verify at least one of the draft tokens, wherein the verification result indicates that a ratio of a first probability of one of the draft tokens to a second probability of the one of the draft tokens is larger than a threshold which is lower than 1, or the one of the draft tokens is identical to a corresponding one of the answer tokens, the one of the draft tokens passes the verification, wherein the first probability of one of the draft tokens is generated by the draft model, and the second probability of one of the draft tokens is generated by the target model, and accept the one of the draft tokens and append a token obtained from the one of the draft tokens or the corresponding one of the answer tokens into a response for the input prompt when the one of the draft tokens passes the verification. The memory is configured to store KV caches of at least one of the multiple answer tokens and at least one of the multiple draft tokens.

With the techniques of proposed union method for Spec-Dec according to implementations of present disclosure, threshold parameters in the verification step of Spec-Dec can have a customized/specified tradeoff between the quality and speedup. In other words, “lossy Spec-Dec” can execute meticulous tradeoff between the quality and the speedup, which provides minimum quality loss while faster inference compared to the conventional method. Additionally, with the techniques of proposed union method for Spec-Dec applied in verification step according to implementations of present disclosure, treasure tokens can be exploited and be accepted.

Accordingly, the proposed union method yields outputs (such as response or final response) that are more similar to the AR output, but at a faster speed, which those techniques of proposed union method can be seamlessly integrated to achieve optimal results.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for larger language model (LLM) inference, comprising:
receiving an input prompt;
generating sequentially a plurality of draft tokens based on the input prompt by a draft model;
generating a plurality of answer tokens in parallel based on the plurality of draft tokens by a target model; and
verifying at least one of the draft tokens,
wherein the verification result indicates that, when a ratio of a first probability of one of the draft tokens to a second probability of the one of the draft tokens is larger than a threshold which is lower than 1, or the one of the draft tokens is identical to a corresponding one of the answer tokens, the one of the draft tokens passes the verification,
wherein the first probability of one of the draft tokens is generated by the draft model, and the second probability of the one of the draft tokens is generated by the target model,
wherein, when the one of the draft tokens passes the verification, the one of the draft tokens are accepted, and a token, obtained from the one of the draft tokens or the corresponding one of the answer tokens, is appended into a response for the input prompt.

2. The method according to claim 1, wherein the token is the one of the draft tokens.

3. The method according to claim 1, wherein when the one of the draft tokens passes the verification and all draft tokens before the one of the draft tokens pass the verification, the one of the draft tokens is accepted.

4. The method according to claim 1, wherein the plurality of draft tokens is γ draft tokens, wherein an ith draft token is generated by the draft model based on an (i−1)th draft token input to the draft model, i is greater than 1 and less than or equal to γ.

5. The method according to claim 1, wherein generating the plurality of answer tokens in parallel based on the plurality of draft tokens comprises generating a plurality of tokens in parallel based on the plurality of draft tokens, wherein the plurality of tokens comprise the plurality of answer tokens and an additional token, wherein the additional token is generated based on the last draft token in the plurality of draft tokens.

6. The method according to claim 5, wherein the plurality of tokens comprise γ answer tokens and the additional token, wherein a first answer token is generated based on the input prompt, an ith answer token is generated based on the first to i−1th draft tokens, and the additional token is generated based on the first to Yth draft tokens.

7. The method according to claim 5, further comprising: if all of the draft tokens are accepted according to the verification result, the additional token is appended into the response.

8. The method according to claim 5, further comprising: if all of the draft tokens are accepted, the draft model receives the last draft token in the plurality of draft tokens and generates KV cache of the last draft token.

9. The method according to claim 1, further comprising: if not all of the draft tokens are accepted according to the verification result, an accepted draft token subset is appended into the response, a token probability distribution of the next position of the accepted draft token subset is adjusted, and a next token is obtained based on the adjusted token probability distribution and appended into the response.

10. The method according to claim 1, further comprising: if not all of the draft tokens are accepted according to the verification result, KV cache of an unaccepted draft token is removed.

11. The method according to claim 1, further comprising: if not all of the draft tokens are accepted according to the verification result, KV cache of the answer token corresponding to an unaccepted draft token is removed.

12. The method according to claim 1, wherein the ratio of the first probability of the one of the draft tokens to the second probability of the one of the draft tokens is referred as
$$\frac{{p}_{i} ( {x}_{q} )}{{q}_{i} ( {x}_{q} )} ,$$
wherein x_{q} represents the one of the draft tokens, and wherein pᵢ(x_{q}) represents the second probability of the one draft token x_{q} at position i and qᵢ(x_{q}) represents the first probability of the one draft token x_{q} at position i.

13. The method according to claim 12, wherein when
$$( \frac{{p}_{i} ( {x}_{q} )}{{q}_{i} ( {x}_{q} )} > {r}_{i} ) ‖ ( {x}_{p} == {x}_{q} ) ,$$
the draft token x_{q} of the draft tokens at position i pass the verification,
wherein when
$$( \frac{{p}_{i} ( {x}_{q} )}{{q}_{i} ( {x}_{q} )} < {r}_{i} ) \& \& ( {x}_{p} ! = {x}_{q} ) ,$$
the draft token x_{q} at position i does not pass the verification,
wherein xₚ represents the corresponding one of the answer tokens, and rᵢ.is the threshold which is between 0.1 and 0.9.

14. The method according to claim 5, further comprising:
generating sequentially a second group of draft tokens based on the input prompt by the draft model, and generating a second group of answer tokens in parallel based on the second group of draft tokens and the additional token generated by the target model if all of the draft tokens are accepted.

15. The method according to claim 9, further comprising:
generating sequentially a second group of draft tokens based on the input prompt by the draft model, and
outputting a second group of answer tokens in parallel based on the second group of draft tokens and the obtained next token generated by the target model if not all of the draft tokens are accepted.

16. A system for LLM inference, comprising:
a processor, configured to receive an input prompt, generate sequentially a plurality of draft tokens based on the input prompt by running a draft model, generate a plurality of answer tokens in parallel based on the plurality of draft tokens by running a target model, verify at least one of the draft tokens, wherein the verification result indicates that, when a ratio of a first probability of one of the draft tokens to a second probability of the one of the draft tokens is larger than a threshold which is lower than 1, or the one of the draft tokens is identical to a corresponding one of the answer tokens, the one of the draft tokens passes the verification, wherein the first probability of one of the draft tokens is generated by the draft model, and the second probability of one of the draft tokens is generated by the target model, wherein, when the one of the draft tokens passes the verification, the one of the draft tokens are accepted, and a token, obtained from the one of the draft tokens or the corresponding one of the answer tokens, is appended into a response for the input prompt;
a memory, configured to store KV caches of at least one of the plurality of answer tokens and at least one of the plurality of draft tokens.

17. The system according to claim 16, wherein the ratio of the first probability of the one of the draft tokens to the second probability of the one of the draft tokens is referred as
$$\frac{{p}_{i} ( {x}_{q} )}{{q}_{i} ( {x}_{q} )} ,$$
wherein x_{q} represents the one of the draft tokens, and wherein pᵢ(x_{q}) represents the second probability of the one draft token x_{q} at position i and qᵢ(x_{q}) represents the first probability of the one draft token x_{q} at position i.

18. The system according to claim 17, wherein when
$$( \frac{{p}_{i} ( {x}_{q} )}{{q}_{i} ( {x}_{q} )} > {r}_{i} ) ‖ ( {x}_{p} == {x}_{q} ) ,$$
the draft token x_{q} of the draft tokens at position i pass the verification,
wherein when
$$( \frac{{p}_{i} ( {x}_{q} )}{{q}_{i} ( {x}_{q} )} < {r}_{i} ) \& \& ( {x}_{p} ! = {x}_{q} ) ,$$
the draft token x_{q} at position i does not pass the verification,
wherein xₚ represents the corresponding one of the answer tokens, and rᵢ.is the threshold which is between 0.1 and 0.9.

19. The system according to claim 16, wherein the processor comprises a CPU and a NPU,
the NPU, configured to receive an input prompt, generate sequentially a plurality of draft tokens based on the input prompt by running a draft model, and generate a plurality of answer tokens in parallel based on the plurality of draft tokens by running a target model;
the CPU, configured to verify at least one of the draft tokens and notify the NPU which draft tokens are accepted.

20. The system according to claim 16, wherein the plurality of answer tokens comprise γ answer tokens, wherein an ith answer token is generated based on the first to i−1th draft tokens, and the one additional token is generated based on the first to Yth draft tokens.
